(19) United States
(12) Patent Application Publication
(10) Pub. No.: US 2006/0016329 A1
(43) Pub. Date: Jan. 26, 2006

(54) Composite fluid actuated cylinder

(75) Inventor: Samuel A. Johnson, Loveland, CO (US)

Correspondence Address: Brian Kinnear;HOLLAND & HART LLP, Suite 3200, 555 17th Street, Denver, CO, 80201, US

(73) Assignee: S.A. Robotics

(21) Appl. No.: 10/899,342

(22) Filed: Jul. 26, 2004

(51) Int. Cl. F16J 10/00

(52) U.S. Cl. 92/169.1

(57) ABSTRACT

A fluid actuator having a honed metallic sleeved inner liner assembled with fitted end caps. The inner liner and end caps are wound with carbon reinforced fiber filaments in both longitudinal and hoop orientations so as to withstand increased fluid pressure over traditional metallic designs. The fluid actuator of the present invention is lightweight and had an extremely stiff piston and rod assembly, which may also be fabricated from high flexural modulus composite materials so as to allow for a very stiff, lightweight, hydraulic cylinder which is particularly resistant to column buckling at long extensions and comprises an economical, non-rebuildable design.

### BACKGROUND OF THE INVENTION

This invention relates generally to hydraulic cylinders used for actuation which permits a substantial weight reduction without sacrificing strength and allows for greatly longer actuation strokes due to the use of high modulus composite fiber for both the cylinder and piston rod assemblies. To provide actuator cylinders having lighter weight than those constructed with a monolithic metal piece but at the same time providing adequate strength, the use of a composite cylinder has been suggested. Typical of such composite cylinders are those disclosed in prior art U.S. Pat. Nos. 5,415,079, 4,685,384, 4,697,499, 4,802,404, and 4,773,306 which are hereby incorporated in their entirety by this reference. The composite cylinders disclosed in these patents include a metal liner which is wound with hoop windings made of a suitable composite fiber such as a graphite filament impregnated with a suitable resin. The filaments, in addition to being hoop wound, have also been helically wound, and in some instances, disposed in longitudinal winding form. The combination of the hoop, helical and longitudinal windings provide the ability for the composite cylinder to react to circumferential loads, axial loads and compressive loads generated in the cylinder during the operation of the hydraulic actuator. Heretofore, in order that the cylinder had the necessary strength and resistance to buckling under fully loaded and extended conditions, it was necessary to greatly oversize the rod diameter to meet the Euler buckling criteria. Such a diameter increase not only increases weight, but also subtracts from the available hydrostatic area developed by the opposing piston face in the generation of net usable pressure.

### SUMMARY OF THE INVENTION

In accordance with one aspect of the invention, a composite wound hydraulic cylinder assembly utilizes pre-assembled sleeve and end caps. A piston and rod may be inserted into the sleeve, and the sleeve and end caps become a mandrel for filament winding operations.

According to other aspects of the invention circumferential or hoop stress windings are provided around the sleeve, which may be a honed metal sleeve to minimize diametral expansion and stresses. The mandrel may also include longitudinal windings at a small wind angle to constrain the pair of end caps against hydrostatic forces acting to push them away from the honed sleeved cylinder.

Also, in accordance with another aspect of the invention, the rod and piston elements are fabricated from high modulus composite fiber so as to provide significant bending moment stiffness and resistance to column buckling over traditional steel rod designs.

### BRIEF DESCRIPTION OF THE DRAWINGS

FIG. 1 is a cut-away perspective view illustrating a composite cylinder in accordance with principles of the present invention.

FIG. 2 is partial cross sectional view illustrating an end cap portion of the composite cylinder shown in FIG. 1.

FIG. 3 is a schematic representation of one end of the cylinder shown in FIG. 1 illustrating a geodesic path of the longitudinal and circumferential hoop windings that may be used according to one embodiment of the present invention.

FIG. 4 is a representative graph plotting buckling loads of a conventional steel cylinder rod versus a composite cylinder rod according to one embodiment of the present invention.

FIG. 5a is a cross sectional view of a composite piston and rod construction that may be disposed inside the cylinder of FIG. 1, showing details of an adhesively joined structure.

FIG. 5b is a cross sectional view of another composite piston and rod construction, showing details of an integrated fiber piston and rod assembly which is co-molded.

### DETAILED DESCRIPTION

A composite cylinder constructed in accordance with the present invention is adapted for use in a wide variety of applications requiring lightweight components, large force, and long strokes. Such hydraulic actuators are particularly well suited for robust, high load robotics, special purpose manipulators, aircraft flight control actuators, or the like. Typically, dual acting capability is required, meaning that pressure can be applied to either side of the piston to effect outward and inward movement on a piston rod. According to some embodiments of the present invention, appropriate fluid inlet and outlet passages and mounting means are included. Although not shown in the embodiments below, composite cylinders including those made according to principles of the present invention may include linear travel indicators, such as linear variable differential transducers (LVDT), or digital or optical encoders. A full implementation of a hydraulic apparatus is not illustrated herein, since such is well known to those skilled in the art.

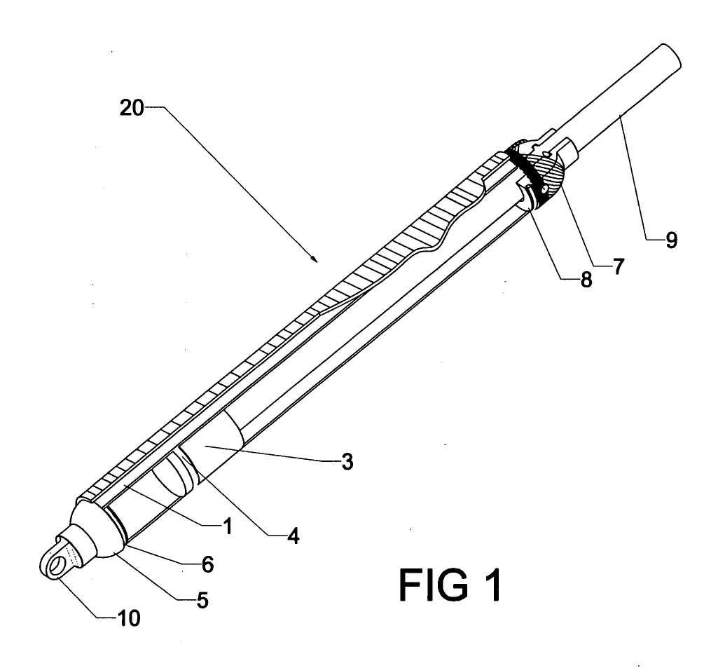

Referring to FIG. 1, a fluid actuator 20, for example a fiber reinforced composite hydraulic cylinder assembly according to one embodiment of the present invention is shown. The fluid actuator 20 includes an integral thin walled liner 1 which terminates at each end to receive pressed and fitted end caps 5, 7. The thin walled liner 1 and the fitted end caps 5, 7 may comprise metal such as stainless steel, aluminum, plain and high strength steels, etc. The fitted end caps 5, 7 overlap with the thin walled liner 1 according to the embodiment of FIG. 1. A wide variety of cylinder mounting configurations can be specified, and usually require differing sets of holes, mounting flanges, etc, to be fitted onto or into the end caps 5, 7. Yoke flange 10 represents one such attachment type, which could be integrated into or threaded onto end cap 5. The variety and diversity are known to those skilled in the art having the benefit of this disclosure, and will not be further presented. End caps 5 and 7 may contain fitted o-rings 6 and 8, respectively, to seal an inner surface of the thin walled liner 1 or they could be welded or sealed with a variety of technologies in order to prevent loss of hydraulic fluid when pressurized. The inner surface of the integral thin walled liner 1 may be hardened and honed to provide high reliability and low wear across thousands of pressurized cycles.

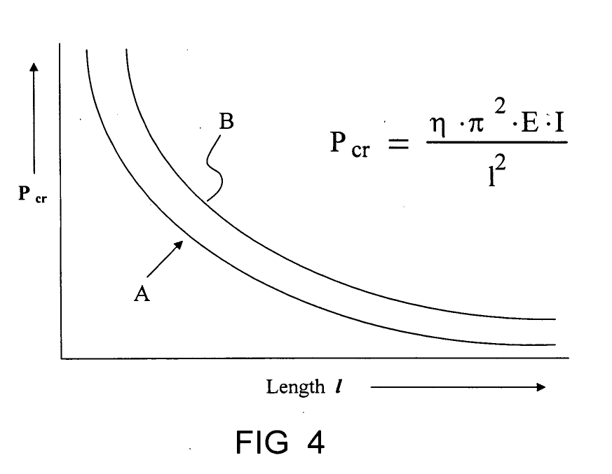

The thin walled liner 1 is receptive of a piston and rod assembly. A piston 3 of the piston and rod assembly shown in FIG. 1 may be precision machined, and fitted with an o-ring groove 4 to accommodate the fitting of a high pressure o-ring seal 11 (FIG. 3). Multiple such o-ring grooves 4 and seals 11 may be incorporated into the design without compromising the nature of the invention.

The piston 3 is attached to a rod 9 as shown in FIG. 1. According to the embodiment of FIG. 1, the piston 3 and/or rod 9 are constructed of composites, such as carbon fiber reinforced composites, and may includes a bonded, plated, or flame sprayed hardened outer metallic coating which is subsequently ground and polished. According to the embodiment of FIG. 1, the rod 9 is preferably constructed with longitudinally oriented high-modulus carbon fiber, although other and additional fiber orientations may also be used. The advantages of rod 9 being constructed using longitudinally oriented high modulus carbon fiber include the ability to achieve longer strokes without column buckling. This is primarily due in fact to the much higher Young's modulus of Ultra-high unidirectional carbon composites. For example, in a preferred embodiment, a Mitsubishi K13C2u fiber constructed with a Fiberite 934 epoxy has a Young's Modulus in the fiber orientation of 81.25 MSI. This is compared to the modulus of steel, which by comparison is 29.5 MSI. Thus, the carbon composite is 2.7 times stiffer in the direction of loading than steel. According to the familiar Euler Equation:
P_{cr}=n π² E I/1²
where: Pcr is the critical buckling load,
n is the type of end constraints applied, and can range from 0.24 to 1.2,
E is Young's Modulus,
I is the moment of inertial of the cross section, and
1 is the column length.

Thus it can be seen that for a given cross section and length, the composite rod construction of the present invention can sustain 2.7 times the loading without buckling than can an equivalent steel rod, and such a composite rod would weigh 6 times less than steel of the same dimensions.

The elements of the composite hydraulic cylinder 20 may be respectively first fitted and assembled, and subsequently the thin walled liner 1 and the end caps 5 and 7 may be over-wound with a plurality of layers of impregnated carbon fiber material to provide the overall additional strength required for a hydraulic actuators while at the same time providing a substantial weight reduction. By using composite materials, such as by filament winding the combination of the thin walled liner 1 and the end caps 5, 7, an overall composite hydraulic actuator 20 weight reduction of approximately 75 percent (75%), as compared to metal actuators, may be realized.

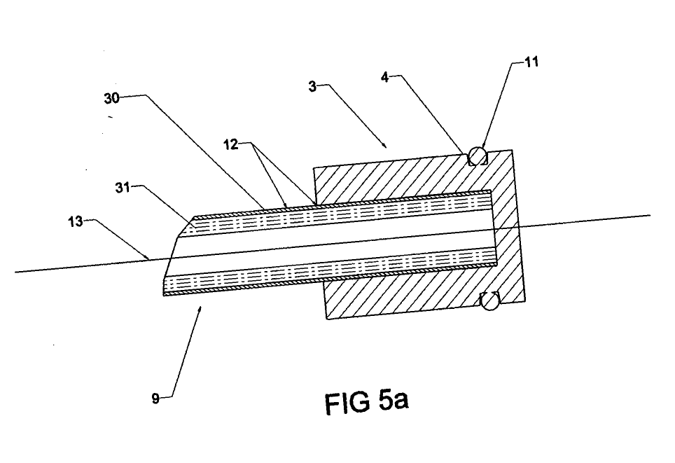

In addition, the buckling strength of the rod 9 may also be greatly increased by employing fiber reinforced composite materials. A comparative estimation of the increase in load carrying capability can be seen by referring to FIG. 4. Curve B represents a rod such as rod 9 that has a higher Young's Modulus than steel, and can be seen to have substantially higher load carrying capability than the steel rod curve, represented by curve A.

As mentioned above, the thin walled liner 1 is preferably constructed of a hardenable stainless steel (15-5 PH) or other metal capable of having a high surface hardness, and may include a central hollow barrel with the separate end fittings 5, 7, which are assembled and become a mandrel for filament winding. The filament used in winding is preferably a carbon fiber which has been impregnated with an epoxy resin, and preferably includes an appropriate curing agent and a curing accelerator as is well known to those skilled in the art having the benefit of this disclosure.

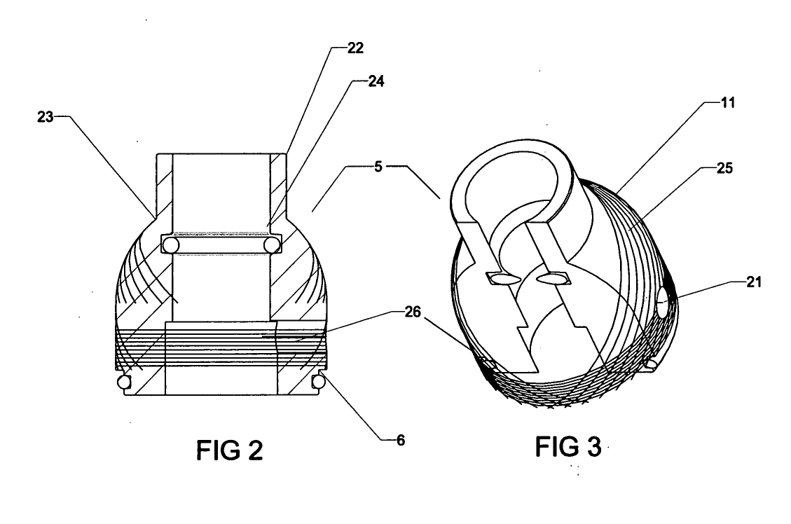

FIG. 2 and FIG. 3 show the constructional details of end cap 5, and by reference, end cap 7 shown in FIG. 1. Fluid passage 21 can be threaded for the passage of pressurized hydraulic fluid into and out of the cylinder assembly 20 (FIG. 1). O-ring seal pocket 23 is designed to receive rod sealing o-ring 24 to make a seal against the cylinder rod 9 shown in FIG. 1. O-ring 6 is shown to seal end cap 5 to liner 1 shown in FIG. 1. Hoop windings 26 are shown to be circumferentially wrapped over the assembled mechanical elements. Such hoop windings provide stiffness to limit the elastic strain and expansion of interior liner 1 shown in FIG. 1. Excessive material strain leads to an expansion of the liner 1 inner diameter, leading to subsequent fluid leakage past piston o-ring 4 of FIG. 1, and o-ring 24 of FIG. 2. In addition to circumferential hoop windings 26 as shown, longitudinal axial windings 25 can also be wound over windings 26 to restrain end caps 5 and 7 of FIG. 1 to limit longitudinal axial motion, thus keeping end caps from blowing out upon the application of high pressure hydraulic forces. For the longitudinal windings 25, it is desirable to utilize high strength fibers, whereas for the circumferential fibers 26, a high stiffness fiber would be preferred to reduce the diametrical expansion of the cylinder liner. Extension mounting boss 22 can be used to mount cylinder assembly 20 (FIG. 1), and can be of a machined, threaded, or other construction commonly used to attach a conventional hydraulic cylinder.

Composite windings are placed around the outer surface of the thin walled liner (FIG. 1) and are preferably helically wound but may also include layers of hoop wound filaments interspersed between the helically wound layers. Helically wound layers are also disposed particularly over the domed or semi-spherical shaped end caps 5, 7 as shown in FIG. 3 in such a manner that radial stress applied during actuator operation will not tend to displace the helically wound filaments of end caps 5,7 from the thin walled liner 1 (FIG. 1). Preferably, the layers of filament are wound continuously without cutting or breaking the filament.

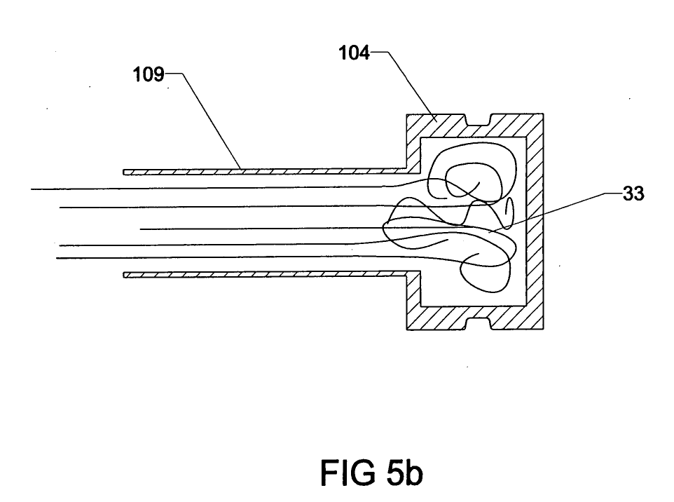

Referring next to FIG. 5a, according to one embodiment of the present invention, piston 3 and rod 9 are attached by adhesive. The piston 3 includes an internal cavity receptive of the rod 9. A layer of adhesive 12 is disposed in an annulus created between cavity of the piston 3 and the rod 9. The successful application of such high performance adhesives and epoxies is well known to those skilled in the art having the benefit of this disclosure. Methods of adhesively attaching the piston 3 to the rod 9 may include, but are not limited to: abrasion, degreasing, acid etching, deionized water soak, plasma etching, etc. It has been shown that by proper adhesive selection and application, very strong and reliable joints can be produced. Use of such an adhesive process allows for a reliable and lightweight piston assembly without traditional fastening hardware which can loosen or jam. Rod 9 can be seen to be comprised of longitudinal high stiffness fibers 31 oriented substantially parallel to a longitudinal axis 13. For example, in a preferred embodiment, a Mitsubishi K13C2u fiber constructed with a Fiberite 934 epoxy has a Young's Modulus in the fiber orientation of 81.25 MSI. Surrounding the fiber/epoxy resin matrix of 31 can be seen to be a hardened outer surface sleeve 30. This can be a tubular steel or aluminum element having a very hard and durable outer coating to resist wear by repeated sliding in the presence of abrasive particles, low lubrication, etc. Alternatively, a single unit molded or pultruded rod/piston combination as shown in FIG. 5b can be constructed by well known molding and hand or automated molding methods. According to the embodiment of FIG. 5b, a composite rod 109 is integral with a composite piston 104. Fibers 33 are shown exiting the rod 109 into a larger molded piston structure 104. Having high strength fibers 33 being continuous as they transition from rod 109 to form an integral molded piston 104 is particularly advantageous in that the same fibers 33 carry the piston to rod loads, thus removing an adhesive interface, and allowing for a smaller overall length of piston than the simpler, preferred adhesively bonded method shown in FIG. 5a.

Although the invention has been shown and described with respect to certain preferred embodiments, it is obvious that equivalent alterations and modifications will occur to others skilled in the art upon the reading and understanding of the specification. The present invention includes all such equivalent alterations and modifications, and is limited only by the scope of the claims.

I claim:

1. A fluid actuator, comprising:
a fiber reinforced composite cylinder assembly;
a piston disposed in the fiber reinforced composite cylinder assembly;
a fiber reinforced composite rod connected to the piston.

2. A fluid actuator according to claim 1, wherein the piston comprises a fiber reinforced composite.

3. A fluid actuator according to claim 2, further comprising a hardened metallic coating disposed over the piston.

4. A fluid actuator according to claim 2, wherein the fiber reinforced composite piston and fiber reinforced composite rod comprise a single-piece integral unit.

5. A fluid actuator according to claim 4 wherein the fiber reinforced composite rod and fiber reinforced composite rod comprises a carbon fiber molded structure.

6. A fluid actuator according to claim 4, further comprising a hardened metallic coating disposed over the fiber reinforced composite piston and rod.

7. A fluid actuator according to claim 1, wherein the piston is adhesively connected to the fiber reinforced composite rod.

8. A fluid actuator according to claim 1, wherein the fiber reinforced composite cylinder assembly further comprises:
a metal liner;
first and second end fittings attached to ends of the metal liner;
a carbon fiber impregnated with an epoxy resin wound about the metal liner and end fittings.

9. A fluid actuator according to claim 8, wherein the carbon fiber is layered in helical and hoop windings.

10. A fluid actuator according to claim 8 wherein the first and second end fittings overlap associated end portions of the metal liner and comprise external domed surfaces.

11. A fluid actuator according to claim 1, wherein the fiber reinforced composite cylinder assembly further comprises:
a liner;
first and second end fittings attached to ends of the liner;
helical and hoop windings about the liner and first and second end fittings as a single unit.

12. A hydraulic actuator, comprising:
a mandrel, the mandrel comprising:
a hollow tube including a hardened metallic interior cylindrical surface;
semi-spherical end caps disposed at each end of the hollow tube;
carbon fiber wound about the mandrel;
a piston and rod assembly comprising carbon fiber reinforcement disposed in the hollow tube.

13. A hydraulic actuator according to claim 12, wherein the piston and rod are adhesively attached to one another.

14. A hydraulic actuator according to claim 12, wherein the piston and rod comprise a single, integrated piece.

15. A hydraulic actuator according to claim 14, wherein the piston and rod comprise a carbon fiber mold.

16. A hydraulic actuator according to claim 12, further comprising a hardened metallic coating disposed over the piston.

17. An assembly, comprising:
a piston having a central cavity
a rod inserted into the central cavity;
an adhesive disposed in an annulus between the central cavity and the rod.

18. An assembly according to claim 17, wherein the adhesive comprises an epoxy.

19. An assembly according to claim 17, wherein the piston comprises a carbon composite and a hardened metallic over layer.

20. An assembly according to claim 17, wherein the rod comprises a carbon fiber composite having longitudinally oriented fibers.

21. A method of making a hydraulic cylinder, comprising:
providing a fiber reinforced cylinder;
inserting a fiber reinforced composite piston and rod into the cylinder.

22. A method of making a hydraulic cylinder according to claim 21, wherein the providing a fiber reinforced cylinder further comprises filament winding a metallic liner.

23. A method of making a hydraulic cylinder according to claim 22, further comprising attaching end caps to ends of the metallic liner, and wherein the filament winding the metallic cylinder comprises winding the end caps and the cylinder as a single unit.

24. A method of making a hydraulic cylinder according to claim 21, further comprising adhesively bonding the piston to the rod.

25. A method of making a hydraulic cylinder according to claim 21, further comprising molding the fiber reinforced composite piston and rod as a unitary piece.

26. A method of making a hydraulic cylinder according to claim 21, further comprising overlaying the piston with a hardened metallic coating.
